(19) United States
(12) Patent Application Publication
(10) Pub. No.: US 2026/0309895 A1
(43) Pub. Date: Oct. 8, 2026

(54) DISPLAY MODULE AND DISPLAY DEVICE

(71) Applicant: Xiamen Tianma Display Technology Co., Ltd., Xiamen (CN)

(72) Inventors: Shuhan CHEN, Xiamen (CN); Fang WAN, Xiamen (CN)

(21) Appl. No.: 19/270,130

(22) Filed: Jul. 15, 2025

(30) Foreign Application Priority Data
Apr. 2, 2025 (CN) 202510410971.1

(51) Int. Cl. G02B 1/14; B32B 3/30; B32B 7/12; B32B 17/06; G02B 5/04

(52) U.S. Cl. CPC G02B 1/14; B32B 3/30; B32B 17/06; G02B 5/045; B32B 7/12; B32B 2457/20

(57) ABSTRACT

The present disclosure discloses a display module. The display module includes: a first display region and a second display region. The second display region surrounds at least a portion of the first display region, and a curvature of the second display region is greater than a curvature of the first display region. The display module includes: a display panel, a cover plate, and an adhesive layer. The cover plate is located on a light-emitting side of the display panel, and the adhesive layer is arranged between the cover plate and the display panel. The display module further includes a first coating layer. The first coating layer is located in the second display region and arranged between the cover plate and the adhesive layer, and a Dyne value of the first coating layer is greater than a Dyne value of a surface of the cover plate adjacent to the adhesive layer.

### CROSS-REFERENCES TO RELATED APPLICATIONS

The present disclosure claims priority to Chinese Patent Application No. 202510410971.1, filed on Apr. 2, 2025, the content of which is incorporated herein by reference in its entirety.

### TECHNICAL FIELD

The present disclosure relates to the field of display technologies, and more specifically, relates to a display module and a display device.

### BACKGROUND

Curved displays may enable narrower bezels and improved tactile experiences, allowing for a larger display area within a limited space. In particular, quad-curved displays may include curved display regions not only on the left and right sides but also on the top and bottom sides, thereby providing an enhanced visual effect. However, in the related technologies, curved displays are prone to bubble formation at the edges of the curved display during low-temperature drop tests, which may negatively affect the reliability and display performance of the curved display.

### SUMMARY

One aspect of the present disclosure provides a display module. The display module includes: a first display region and a second display region. The second display region surrounds at least a portion of the first display region, and a curvature of the second display region is greater than a curvature of the first display region. The display module includes: a display panel, a cover plate, and an adhesive layer. The cover plate is located on a light-emitting side of the display panel, and the adhesive layer is arranged between the cover plate and the display panel. The display module further includes a first coating layer. The first coating layer is located in the second display region and arranged between the cover plate and the adhesive layer, and a Dyne value of the first coating layer is greater than a Dyne value of a surface of the cover plate adjacent to the adhesive layer.

Another aspect of the present disclosure provides a display device, where the display device includes a display module. The display module includes: a first display region and a second display region. The second display region surrounds at least a portion of the first display region, and a curvature of the second display region is greater than a curvature of the first display region. The display module includes: a display panel, a cover plate, and an adhesive layer. The cover plate is located on a light-emitting side of the display panel, and the adhesive layer is arranged between the cover plate and the display panel. The display module further includes a first coating layer. The first coating layer is located in the second display region and arranged between the cover plate and the adhesive layer, and a Dyne value of the first coating layer is greater than a Dyne value of a surface of the cover plate adjacent to the adhesive layer.

### BRIEF DESCRIPTION OF THE DRAWINGS

The drawings described herein are incorporated into and constitute a part of the present specification. The drawings illustrate embodiments consistent with the present disclosure and, together with the detailed description, serve to explain the principles of the present disclosure.

To more clearly illustrate the embodiments of the present disclosure, a brief introduction to the drawings required for the description of the embodiments is provided below. It should be readily apparent to those skilled in the art that other drawings may also be obtained based on these drawings without any creative effort.

FIG. 1 illustrates a schematic plan view of a display module according to the present disclosure;

FIG. 2 illustrates a cross-sectional view of the display module shown in FIG. 1 along line A-A′;

FIG. 3 illustrates another cross-sectional view of the display module shown in FIG. 1 along line A-A′;

FIG. 4 illustrates an enlarged view of portion B of the display module shown in FIG. 3;

FIG. 5 illustrates yet another cross-sectional view of the display module shown in FIG. 1 along line A-A′;

FIG. 6 illustrates an enlarged view of portion C of the display module shown in FIG. 5;

FIG. 7 illustrates yet another cross-sectional view of the display module shown in FIG. 1 along line A-A′;

FIG. 8 illustrates yet another cross-sectional view of the display module shown in FIG. 1 along line A-A′;

FIG. 9 illustrates yet another cross-sectional view of the display module shown in FIG. 1 taken along line A-A′;

FIG. 10 illustrates yet another cross-sectional view of the display module shown in FIG. 1 along line A-A′;

FIG. 11 illustrates yet another cross-sectional view of the display module shown in FIG. 1 along line A-A′;

FIG. 12 illustrates yet another cross-sectional view of the display module shown in FIG. 1 taken along line A-A′;

FIG. 13 illustrates an enlarged view of portion D of the display module shown in FIG. 12;

FIG. 14 illustrates yet another cross-sectional view of the display module shown in FIG. 1 along line A-A′;

FIG. 15 illustrates yet another cross-sectional view of the display module shown in FIG. 1 along line A-A′;

FIG. 16 illustrates yet another cross-sectional view of the display module shown in FIG. 1 along line A-A′;

FIG. 17 illustrates yet another cross-sectional view of the display module shown in FIG. 1 along line A-A′;

FIG. 18 illustrates yet another cross-sectional view of the display module shown in FIG. 1 along line A-A′;

FIG. 19 illustrates an enlarged view of portion E of the display module shown in FIG. 18; and

FIG. 20 illustrates a schematic plan view of a display device according to the present disclosure.

### DETAILED DESCRIPTION

To facilitate a clearer understanding of the objectives, features, and advantages of the present disclosure, the following provides a further description of the technical solutions of the present disclosure. It should be noted that, unless a conflict arises, the features of the embodiments of the present disclosure may be combined with each other.

Numerous specific details are set forth in the description below to facilitate a full understanding of the present disclosure. However, the present disclosure may also be implemented in ways different from those described herein. It is apparent that the embodiments in the specification are merely a portion of the embodiments of the present disclosure and not all of them.

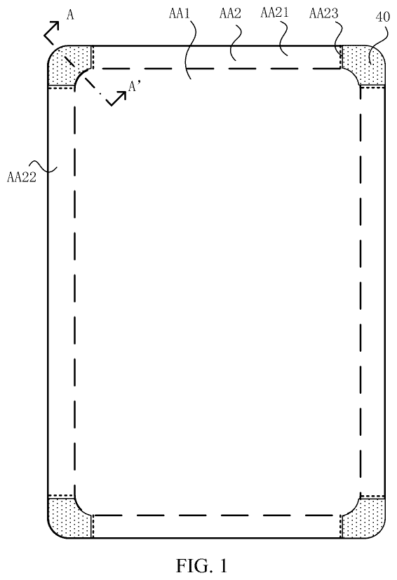

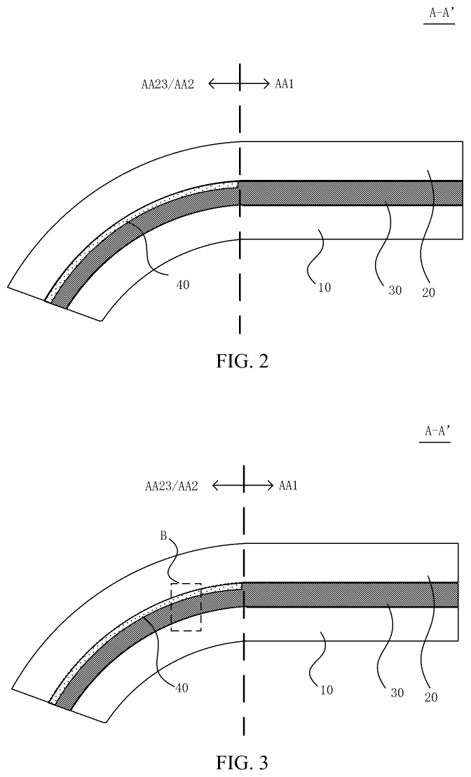

FIG. 1 illustrates a schematic plan view of a display module provided by the present disclosure. FIG. 2 illustrates a cross-sectional view of the display module shown in FIG. 1 along line A-A′. With reference to FIGS. 1 and 2, some embodiments of the present disclosure provide a display module. The display module includes: a first display region AA1, and a second display region AA2. The second display region AA2 surrounds at least a portion of the first display region AA1. A curvature of the second display region AA2 is greater than a curvature of the first display region AA1.

The display module further includes: a display panel 10, a cover plate 20, and an adhesive layer 30. Where, the cover plate 20 is located on a light-emitting side of the display panel 10, and the adhesive layer 30 is located between the cover plate 20 and the display panel 10.

The display module further includes a first coating layer 40. The first coating layer 40 is located in the second display region AA2 and is arranged between the cover plate 20 and the adhesive layer 30. A Dyne value of the first coating layer 40 is greater than a Dyne value of a surface of the cover plate 20 adjacent to the adhesive layer 30.

Specifically, the display module as disclosed herein includes: a first display region AA1, and a second display region AA2. Both the first display region AA1 and the second display region AA2 are configured to display images. The curvature of the second display region AA2 is greater than the curvature of the first display region AA1, meaning that the second display region AA2 is more curved than the first display region AA1. The first display region AA1 may be a planar display region, i.e., the curvature of the first display region AA1 may be 0.

The display module further includes: a display panel 10, a cover plate 20, and an adhesive layer 30. The display panel 10 is a flexible display panel, i.e., the display panel 10 includes a flexible substrate. The flexible substrate may be a flexible polymer material, allowing the display panel 10 to be bendable. The display panel 10 includes portions located in both the first display region AA1 and the second display region AA2 and further includes a plurality of display devices (not shown in the figure), enabling the first display region AA1 and the second display region AA2 of the display module to display images. The cover plate 20 may be a glass cover plate or another type of encapsulating cover plate. The cover plate 20 is arranged on the light-emitting side of the display panel 10 and is primarily used to protect the display panel 10, preventing external impact from damaging the display devices within the display panel 10. The adhesive layer 30 is bonded between the cover plate 20 and the display panel 10, thereby achieving bonding between the cover plate 20 and the display panel 10.

Currently, to meet customer requirements, the display module is subjected to a low-temperature drop test before leaving the factory. During the low-temperature drop test, the curvature of the second display region is relatively high, and the cover plate in the second display region experiences the greatest impact force. This impact may generate shear forces between the adhesive layer and the cover plate that tend to separate the adhesive layer and the cover plate. Since the characteristics of the adhesive layer may change under low-temperature conditions-primarily in that the adhesive layer becomes harder and less adhesive-the portion of the cover plate located in the second display region may deform during the drop. As a result, the shear force between the adhesive layer and the cover plate in the second display region may exceed the bonding strength between the adhesive layer and the cover plate, making separation more likely and leading to bubble formation, which adversely affects the reliability and display quality of the display module.

As disclosed herein, the display module also includes a first coating 40, and the first coating 40 is located in the second display region AA2 and located between the cover plate 20 and the adhesive layer 30. That is, the first coating layer 40 is arranged on a surface of the cover plate 20 in the second display region AA2 facing the display panel 10. The Dyne value of the first coating layer 40 is relatively high, i.e., greater than the Dyne value of the surface of the cover plate 20 adjacent to the adhesive layer 30. The presence of the first coating layer 40 is advantageous for increasing the bonding strength between the adhesive layer 30 and the cover plate 20 in at least a portion of the second display region AA2. Therefore, during low-temperature drop testing, the bonding strength between the adhesive layer 30 and the cover plate 20 in at least part of the second display region AA2 may remain greater than the shear force that results from the impact. Even when the adhesive properties of the adhesive layer 30 decrease at low temperatures, the adhesive layer 30 and the cover plate 20 in at least a portion of the second display region AA2 may remain firmly bonded. This reduces the risk that the shear force may exceed the bonding strength between the adhesive layer 30 and the cover plate 20, thereby preventing bubble formation and improving the reliability and display performance of the display module. The Dyne value of the first coating 40 is relatively large, that is, the Dyne value of the first coating 40 is greater than the Dyne value of the surface of the cover plate 20 adjacent to the bonding layer 30. The setting of the first coating 40 with a higher Dyne value is conducive to reducing the generation of bubbles during the bonding process between the cover plate 20 and the bonding layer 30, thereby improving the display performance of the display module.

It should be noted that the Dyne value of the first coating 40 may be flexibly adjusted according to the specific conditions of the cover plate 20 and the adhesive layer 30. For example, the Dyne value of the first coating 40 may be set within the range of 38-50 Dyne/cm, and the Dyne value of the first coating 40 may be ensured to be greater than the Dyne value of the surface of the cover plate 20 adjacent to the adhesive layer 30. The disclosure will not be repeated here.

It should also be noted that the cover plate 20 is used to protect the display panel 10 and to prevent external forces from damaging the display devices within the display panel 10. Therefore, during low-temperature drop testing, most of the impact force is absorbed by the cover plate 20, and the resulting shear force is concentrated between the cover plate 20 and the adhesive layer 30. Accordingly, this embodiment improves the bonding strength in the second display region AA2 by providing a first coating layer 40 with a high Dyne value on the portion of the cover plate 20 located in the second display region AA2. This helps reduce the risk of separation and bubble formation between the adhesive layer 30 and the cover plate 20 during low-temperature drop testing and also minimizes bubble generation during bonding.

With continued reference to FIGS. 1 and 2, in some embodiments, the second display region AA2 includes a first edge region AA21, a second edge region AA22, and a corner region AA23. The extending direction of the first edge region AA21 intersects with the extending direction of the second edge region AA22, and the two edge regions meet at the corner region AA23. The first coating layer 40 is at least arranged in the corner region AA23.

Specifically, the second display region AA2 includes a first edge region AA21, a second edge region AA22, and a corner region AA23. The first edge region AA21 and second edge region AA22 intersect, and the corner region AA23 includes portions of both the first edge region AA21 and second edge region AA22. Since the curvature of the first edge region AA21 is greater than the curvature of the second edge region AA22, the corner region AA23 includes areas with different curvatures and is therefore subject to the greatest shear force during low-temperature drop testing. Thus, the first coating layer 40 is arranged in the corner region AA23-specifically on the surface of the cover plate 20 in the corner region AA23 that faces the display panel 10. The Dyne value of the first coating 40 is relatively large, that is, the Dyne value of the first coating layer 40 is greater than the Dyne value of the surface of the cover plate 20 adjacent to the adhesive layer 30. Accordingly, the provision of the first coating layer 40 is advantageous for increasing the bonding strength between the adhesive layer 30 and the cover plate 20 in the corner region AA23, such that, during low-temperature drop testing, the bonding strength between the adhesive layer 30 and the cover plate 20 in the corner region AA23 is greater than the shear force generated between the adhesive layer 30 and the cover plate 20 in the corner region AA23 after impact. As a result, even when the adhesive properties of the adhesive layer 30 degrade under low-temperature conditions, the adhesive layer 30 and the cover plate 20 in the corner region AA23 may remain firmly bonded, thereby reducing the risk that, during low-temperature drop testing, the shear force between the adhesive layer 30 and the cover plate 20 in the corner region AA23 exceeds the bonding strength and causes separation and bubble formation, and improving the reliability and display performance of the display module.

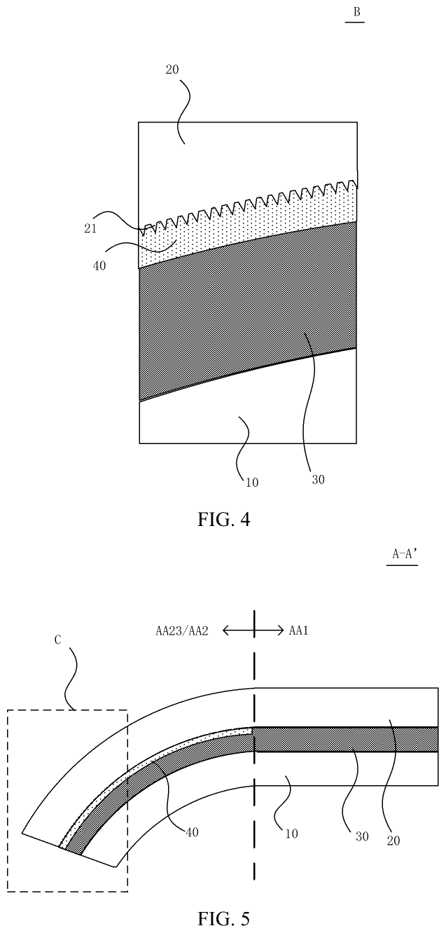

FIG. 3 illustrates another cross-sectional view of the display module shown in FIG. 1 along line A-A′. FIG. 4 illustrates an enlarged view of portion B of the display module shown in FIG. 3. With reference to FIGS. 1, 3, and 4, in some embodiments, the surface of the cover plate 20 adjacent to the display panel 10 is provided with a microprism structure 21. The microprism structure 21 is arranged in the second display region AA2, and at least a portion of the microprism structure 21 is in contact with the first coating layer 40.

Specifically, a microprism structure 21 is provided on the surface of the cover plate 20 adjacent to the display panel 10, and the microprism structure 21 is located in the second display region AA2. That is, the microprism structure 21 is formed on the surface of the cover plate 20 adjacent to the display panel 10, which is advantageous for increasing the surface roughness of the side of the cover plate 20 facing the display panel 10. At least a portion of the microprism structure 21 is in contact with the first coating layer 40. That is, the microprism structure 21 is first formed on the surface of the cover plate 20 adjacent to the display panel 10 in the second display region AA2, and then the first coating layer 40 is formed on the surface of the cover plate 20 adjacent to the display panel 10. This facilitates application of the first coating layer 40 onto the cover plate 20 and increases the actual contact area between the cover plate 20 and the first coating layer 40, which may significantly enhance the adhesion strength between the first coating layer 40 and the cover plate 20, effectively reduce the risk of delamination between the first coating layer 40 and the cover plate 20 and improve the reliability of the display module.

A curvature of the second display region AA2 is greater than that of the first display region AA1, meaning that the second display region AA2 is more highly curved. As a result, light emitted from the display panel 10 in the second display region AA2 is subject to greater reflective interference. The microprism structure 21 is arranged in the second display region AA2 and is capable of scattering light, which is advantageous for reducing reflective interference in the second display region AA2 and improving the display performance.

The microprism structure 21 may be directly formed on a surface of the cover plate 20 adjacent to the display panel 10 by thermal bending using a mold. Alternatively, the microprism structure 21 may be formed on an inner surface of the cover plate 20 after molding by etching or by physical or chemical deposition. Other fabrication processes may also be employed to form the microprism structure 21 on the surface of the cover plate 20 adjacent to the display panel 10, and further description is omitted here.

It should be noted that, illustratively shown in FIGS. 3 and 4, the microprism structure 21 is formed as a protrusion on the surface of the cover plate 20 adjacent to the display panel 10. In other embodiments of the present disclosure, the microprism structure may alternatively be formed as a recess on the surface of the cover plate adjacent to the display panel. Further description is omitted here.

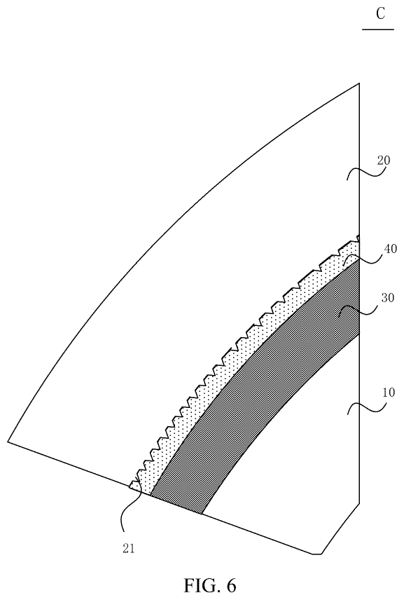

FIG. 5 illustrates yet another cross-sectional view of the display module shown in FIG. 1 along line A-A′, and FIG. 6 is an enlarged view of portion C of the display module shown in FIG. 5. With reference to FIGS. 1, 5, and 6, in some embodiments, a density of the microprism structure 21 gradually increases in a direction from the first display region AA1 toward the second display region AA2.

Specifically, the curvature of the second display region AA2 is greater than the curvature of the first display region AA1. As such, the second display region AA2 requires stronger adhesion to withstand the stress induced by the increased curvature. Moreover, in a direction from the first display region AA1 toward the second display region AA2, the stress caused by the curvature in the second display region AA2 gradually increases. Accordingly, the density of the microprism structure 21 is gradually increased in the direction from the first display region AA1 toward the second display region AA2. The increased density of the microprism structure 21 may enhance the surface roughness of the cover plate 20 and improve the bonding with the first coating layer 40. That is, in a direction from the first display region AA1 toward the second display region AA2, the adhesion strength between the first coating layer 40 and the cover plate 20 gradually increases, further reducing the risk of delamination therebetween and improving the reliability of the display module. In addition, the gradual increase in the density of the microprism structure 21 in the direction from the first display region AA1 toward the second display region AA2 contributes to the structural stability of the regions of the cover plate 20 corresponding to the first coating layer 40, helping to avoid stress concentration caused by abrupt changes in structure.

The curvature of the second display region AA2 is greater than the curvature of the first display region AA1, meaning that the second display region AA2 is more highly curved. As a result, light emitted from the display panel 10 in the second display region AA2 is subject to increased reflective interference. Moreover, in a direction from the first display region AA1 toward the second display region AA2, the reflective interference experienced in the second display region AA2 gradually increases. Accordingly, the density of the microprism structure 21 is gradually increased in the direction from the first display region AA1 toward the second display region AA2, which is advantageous for equalizing the degree of reflective interference across different areas of the second display region AA2 and improving display uniformity.

FIG. 7 illustrates yet another cross-sectional view of the display module shown in FIG. 1 taken along line A-A′. With reference to FIGS. 1 and 7, in some embodiments, a surface of the cover plate 20 adjacent to the display panel 10 is provided with a plurality of grooves 22, where the grooves 22 are recessed in a direction away from the display panel 10, and the first coating layer 40 is located within the grooves 22.

Specifically, a surface of the cover plate 20 adjacent to the display panel 10 is provided with a plurality of grooves 22, where the grooves 22 are recessed in a direction away from the display panel 10, and the first coating layer 40 is located within the grooves 22. The grooves 22 are advantageous for locking the coating material in place, preventing displacement or loss of the coating material during subsequent processes, and ensuring the uniformity and stability of the subsequently formed first coating layer 40. The first coating layer 40 has a relatively high Dyne value, that is, the Dyne value of the first coating layer 40 is greater than the Dyne value of the surface of the cover plate 20 adjacent to the adhesive layer 30. Accordingly, the first coating layer 40 arranged within the grooves 22 is beneficial for increasing the bonding strength between the adhesive layer 30 and the cover plate 20 in at least a portion of the second display region AA2. As a result, during low-temperature drop testing, the bonding strength between the adhesive layer 30 and the cover plate 20 in at least part of the second display region AA2 may remain greater than the shear force generated therebetween after impact. Even when the adhesive properties of the adhesive layer 30 degrade under low-temperature conditions, the adhesive layer 30 and the cover plate 20 in at least a portion of the second display region AA2 may remain firmly bonded. This reduces the risk that the shear force between the adhesive layer 30 and the cover plate 20 in the second display region AA2 during low-temperature drop testing may exceed the bonding strength between the adhesive layer 30 and the cover plate 20, causing delamination and bubble formation, and thus improves the reliability and display performance of the display module. In addition, the first coating layer 40 has a relatively high Dyne value, that is, the Dyne value of the first coating 40 is greater than the Dyne value of the surface of the cover plate 20 adjacent to the adhesive layer 30. The provision of the high-Dyne first coating layer 40 is advantageous for reducing bubble formation during the bonding process between the cover plate 20 and the adhesive layer 30, thereby further enhancing the display performance of the display module.

In addition, since the first coating layer 40 is arranged within the grooves 22, the encapsulating effect of the grooves 22 on the first coating layer 40 may reduce erosion of the coating material by external environmental factors, such as humidity and high temperature, thereby prolonging the stability of the interfacial bonding.

Furthermore, the surface of the cover plate 20 adjacent to the display panel 10 is provided with the plurality of grooves 22, where the grooves 22 are recessed in a direction away from the display panel 10, and the first coating layer 40 is arranged within the grooves 22. This configuration is advantageous for allowing the adhesive layer 30 to spread more uniformly in the second display region AA2, thereby promoting uniformity in the thickness of the adhesive layer 30, contributing to uniform overall thickness of the display module and improving the overall luminance uniformity of the display module.

Furthermore, the grooves 22 formed on the surface of the cover plate 20 adjacent to the display panel 10 in the second display region AA2 may effectively absorb stress generated during bending of the second display region AA2, thereby preventing stress concentration that may otherwise cause cracking of the cover plate 20. In addition, the grooves 22 in the second display region AA2 may deform in synchrony during dynamic bending, which reduces interfacial shear stress and further lowers the risk of separation between the adhesive layer 30 and the cover plate 20 that may lead to bubble formation, thereby enhancing the reliability and display performance of the display module.

With continued reference to FIGS. 1 and 7, in some embodiments, a height of the first coating layer 40 is equal to a depth of the grooves 22 in a direction perpendicular to the display panel 10.

Specifically, a surface of the cover plate 20 adjacent to the display panel 10 is provided with a plurality of grooves 22, where the grooves 22 are recessed in a direction away from the display panel 10, and the first coating layer 40 fills the grooves 22. In a direction perpendicular to the display panel 10, a height of the first coating layer 40 is equal to a depth of the grooves 22, such that a surface of the first coating layer 40 adjacent to the display panel 10 is flush with the surface of the cover plate 20 adjacent to the display panel 10. This configuration is advantageous for improving the spreading uniformity of the adhesive layer 30 and enhancing the bonding yield between the display panel 10 and the cover plate 20 in the display module.

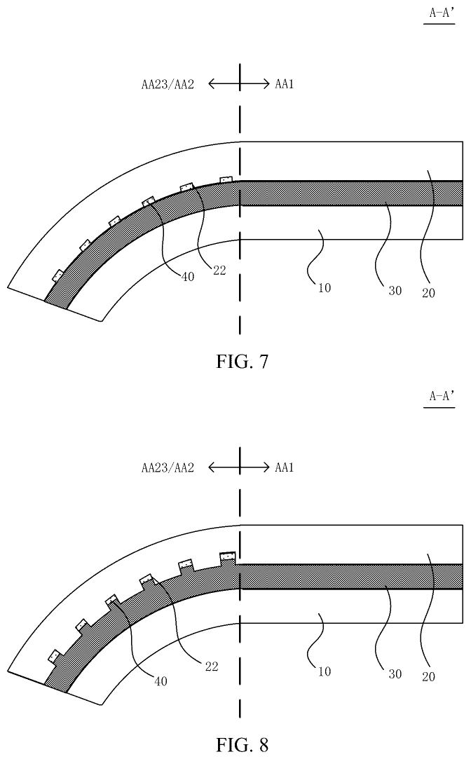

FIG. 8 illustrates yet another cross-sectional view of the display module shown in FIG. 1 along line A-A′. With reference to FIGS. 1 and 8, in some embodiments, a height of the first coating layer 40 is less than a depth of the grooves 22 in a direction perpendicular to the display panel 10; and a portion of the adhesive layer 30 is located within the groove 22.

Specifically, a surface of the cover plate 20 adjacent to the display panel 10 is provided with a plurality of grooves 22, where the grooves 22 are recessed in a direction away from the display panel 10, and the first coating layer 40 fills the grooves 22. In a direction perpendicular to the display panel 10, a height of the first coating layer 40 is less than a depth of the grooves 22, meaning that the first coating layer 40 does not fully fill the grooves 22. As a result, when the cover plate 20 is bonded to the display panel 10, a portion of the adhesive layer 30 is located within the grooves 22, such that the adhesive layer 30 is in contact with both the first coating layer 40 and the cover plate 20 within the groove 22. The sidewalls of the grooves 22 and the embedded adhesive layer 30 form an interlocking structure that effectively resists shear forces generated between the adhesive layer 30 and the cover plate 20 in the second display region AA2 during low-temperature drop testing. This configuration significantly reduces the risk of delamination and bubble formation between the adhesive layer 30 and the cover plate 20, thereby improving the reliability and display performance of the display module. Moreover, since a portion of the adhesive layer 30 is located within the grooves 22, the contact area between the adhesive layer 30 and the cover plate 20 is increased, which may significantly enhance the adhesion strength among the adhesive layer 30, the first coating layer 40, and the cover plate 20, thereby reducing the risk of delamination and further improving the reliability of the display module.

In addition, the adhesive layer 30 located within the groove 22 may effectively absorb stress generated during bending of the second display region AA2, thereby preventing stress concentration that may otherwise lead to cracking of the cover plate 20.

FIG. 9 illustrates yet another cross-sectional view of the display module shown in FIG. 1 along line A-A′. With reference to FIGS. 1 and 9, in some embodiments, the groove 22 includes a first bottom 221 and a first top 222, and the first bottom 221 and the first top 222 are arranged opposite to each other. The first bottom 221 is located at an end of the groove 22 away from the display panel 10, and the first top 222 is located at an end of the groove 22 close to the display panel 10. An area of a vertical projection pattern of the first bottom 221 onto the display panel 10 is greater than an area of a vertical projection pattern of the first top 222 onto the display panel 10.

Specifically, the groove 22 includes a first bottom 221 and a first top 222, and the first bottom 221 and the first top 222 are arranged opposite to each other. The first bottom 221 is located at an end of the groove 22 away from the display panel 10, and the first top 222 is located at an end of the groove 22 close to the display panel 10. A size of the first bottom 221 is greater than a size of the first top 222. A surface of the cover plate 20 adjacent to the display panel 10 is provided with a plurality of grooves 22, where the grooves 22 are recessed in a direction away from the display panel 10. The first coating layer 40 fills the grooves 22, and in a direction perpendicular to the display panel 10, a height of the first coating layer 40 is less than a depth of the grooves 22, such that the first coating layer 40 does not fully fill the grooves 22. As a result, when the cover plate 20 is bonded to the display panel 10, a portion of the adhesive layer 30 is located within the grooves 22. The grooves 22 and the portion of the adhesive layer 30 located inside the grooves 22 form an interlocking structure, which may further enhance the adhesion strength between the adhesive layer 30, the first coating layer 40, and the cover plate 20, effectively reducing the risk of delamination and improving the reliability of the display module.

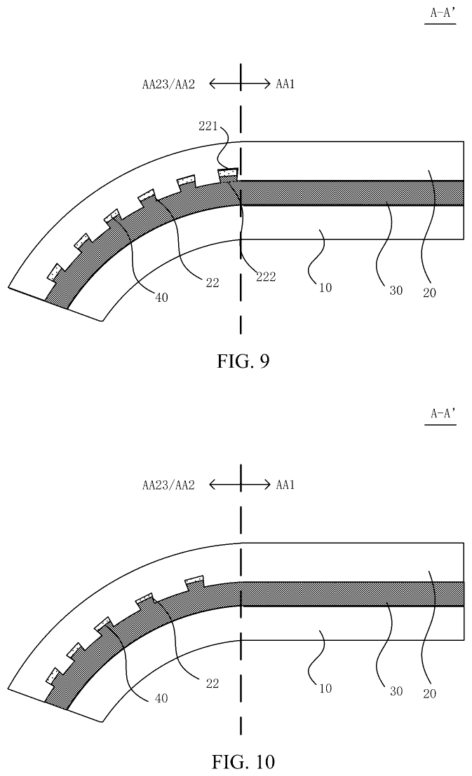

FIG. 10 illustrates yet another cross-sectional view of the display module shown in FIG. 1 along line A-A′. With reference to FIGS. 1 and 10, in some embodiments, a density of the grooves 22 gradually increases in a direction from the first display region AA1 toward the second display region AA2.

Specifically, the curvature of the second display region AA2 is greater than the curvature of the first display region AA1. During low-temperature drop testing, the shear force generated in the second display region AA2 after impact is relatively large, with the greatest shear force occurring at the end of the second display region AA2 away from the first display region AA1. Accordingly, the density of the grooves 22 is gradually increased in a direction from the first display region AA1 toward the second display region AA2. Correspondingly, the density of the first coating layer 40 is also gradually increased in the same direction. The first coating layer 40 has a relatively high Dyne value, and the first coating layer 40 arranged in the grooves 22 is advantageous for enhancing the bonding strength between the adhesive layer 30 and the cover plate 20. As a result, the bonding strength between the adhesive layer 30 and the cover plate 20 gradually increases in a direction from the first display region AA1 toward the second display region AA2, such that in all areas of the second display region AA2, the bonding strength between the adhesive layer 30 and the cover plate 20 remains greater than the shear force generated therebetween during low-temperature drop testing. Therefore, even when the adhesive properties of the adhesive layer 30 are reduced in a low-temperature environment, the adhesive layer 30 and the cover plate 20 in various regions of the second display region AA2 may remain firmly bonded. This reduces the risk that the shear force in the second display region AA2 during low-temperature drop testing exceeds the bonding strength between the adhesive layer 30 and the cover plate 20, which may otherwise result in delamination and bubble formation, thereby improving the reliability and display performance of the display module.

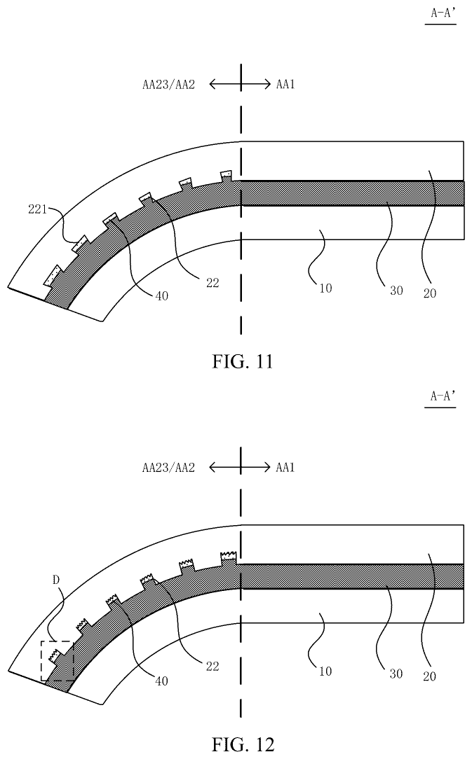

FIG. 11 illustrates yet another cross-sectional view of the display module shown in FIG. 1 along line A-A′. With reference to FIGS. 1 and 11, in some embodiments, the groove 22 includes a first bottom 221. The first bottom 221 is located at an end of the groove 22 away from the display panel 10. In a direction from the first display region AA1 toward the second display region AA2, an area of a vertical projection pattern of the first bottom 221 onto the display panel 10 gradually increases.

Specifically, the curvature of the second display region AA2 is greater than the curvature of the first display region AA1. During low-temperature drop testing, the shear force generated in the second display region AA2 after impact is relatively large, with the greatest shear force occurring at the end of the second display region AA2 away from the first display region AA1. Accordingly, in a direction from the first display region AA1 toward the second display region AA2, an area of a vertical projection pattern of the first bottom 221 onto the display panel 10 gradually increases. Correspondingly, in the same direction, the size of the first coating layer 40 also gradually increases. The first coating layer 40 has a relatively high Dyne value, and the presence of the first coating layer 40 within the groove 22 is advantageous for enhancing the bonding strength between the adhesive layer 30 and the cover plate 20. As a result, in a direction from the first display region AA1 toward the second display region AA2, the bonding strength between the adhesive layer 30 and the cover plate 20 gradually increases, such that in each region of the second display region AA2, the bonding strength between the adhesive layer 30 and the cover plate 20 remains greater than the shear force generated therebetween after impact during low-temperature drop testing. Therefore, even when the adhesive properties of the adhesive layer 30 are reduced under low-temperature conditions, the adhesive layer 30 and the cover plate 20 in different regions of the second display region AA2 may remain firmly bonded. This reduces the risk that the shear force between the adhesive layer 30 and the cover plate 20 in the second display region AA2 exceeds the bonding strength therebetween during low-temperature drop testing, which may otherwise result in delamination and bubble formation, thereby improving the reliability and display performance of the display module.

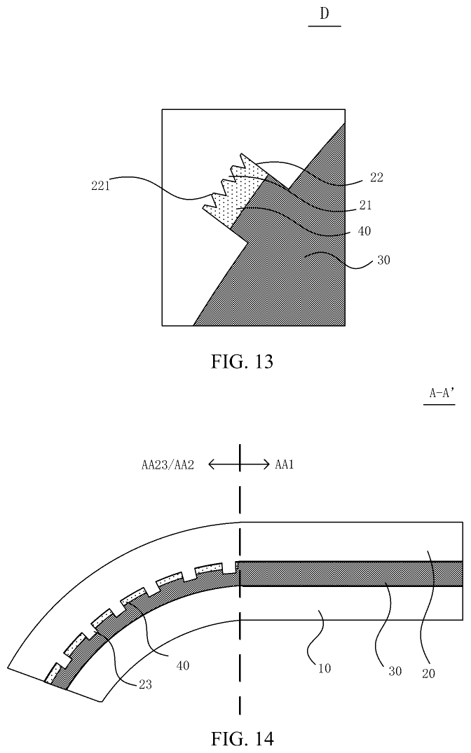

FIG. 12 illustrates yet another cross-sectional view of the display module shown in FIG. 1 along line A-A′, and FIG. 13 is an enlarged view of portion D of the display module shown in FIG. 12. With reference to FIGS. 1, 12, and 13, in some embodiments, the groove 22 includes a first bottom 221. The first bottom 221 is located at an end of the groove 22 away from the display panel 10, and the first bottom 221 is provided with a microprism structure 21.

Specifically, the first bottom 221 is provided with a microprism structure 21, which is advantageous for increasing the surface roughness of the first bottom 221. This facilitates the formation of the first coating layer 40 within the groove 22 and increases the actual contact area between the first bottom 221 and the first coating layer 40. As a result, the adhesion strength between the first coating layer 40 and the first bottom 221 may be significantly improved, effectively reducing the risk of delamination between the first coating layer 40 and the cover plate 20, thereby enhancing the reliability of the display module.

The curvature of the second display region AA2 is greater than the curvature of the first display region AA1, meaning that the second display region AA2 is more highly curved. As such, light emitted from the display panel 10 in the second display region AA2 is more susceptible to reflective interference. In the second display region AA2, the first bottom 221 of the groove 22 is provided with the microprism structure 21, and the microprism structure 21 may scatter light, thereby reducing reflective interference in the second display region AA2 and improving the overall display performance.

With continued reference to FIGS. 1, 12, and 13, in some embodiments, a height of the microprism structure 21 is less than a depth of the groove 22 in a direction perpendicular to the display panel 10.

Specifically, the groove 22 is recessed in a direction away from the display panel 10, and the first coating layer 40 is located within the groove 22. In a direction perpendicular to the display panel 10, a height of the microprism structure 21 is less than a depth of the groove 22, such that the presence of the microprism structure 21 does not interfere with the placement of the first coating layer 40 within the groove 22.

FIG. 14 illustrates yet another cross-sectional view of the display module shown in FIG. 1 along line A-A′. With reference to FIGS. 1 and 14, in some embodiments, a surface of the cover plate 20 adjacent to the display panel 10 is provided with a plurality of protrusions 23. The protrusions 23 protrude in a direction toward the display panel 10, and the first coating layer 40 is arranged between adjacent protrusions 23.

Specifically, a surface of the cover plate 20 adjacent to the display panel 10 is provided with a plurality of protrusions 23. The protrusions 23 protrude in a direction toward the display panel 10, and the first coating layer 40 is arranged between adjacent protrusions 23. The protrusions 23 are advantageous for locking the coating material in place, preventing displacement or loss of the coating material during subsequent processing, and ensuring the uniformity and stability of the subsequently formed first coating layer 40. The first coating layer 40 has a relatively high Dyne value, that is, the Dyne value of the first coating layer 40 is greater than the Dyne value of the surface of the cover plate 20 adjacent to the adhesive layer 30. Accordingly, the first coating layer 40 arranged between adjacent protrusions 23 is beneficial for increasing the bonding strength between the adhesive layer 30 and the cover plate 20 in at least a portion of the second display region AA2. As a result, during low-temperature drop testing, the bonding strength between the adhesive layer 30 and the cover plate 20 in at least part of the second display region AA2 remains greater than the shear force generated therebetween after impact. Therefore, even when the adhesive properties of the adhesive layer 30 are reduced in a low-temperature environment, the adhesive layer 30 and the cover plate 20 in at least a portion of the second display region AA2 may remain firmly bonded. This reduces the risk that, during low-temperature drop testing, the shear force between the adhesive layer 30 and the cover plate 20 in the second display region AA2 exceeds the bonding strength force between the adhesive layer 30 and the cover plate 20, which may otherwise result in delamination and bubble formation, thereby improving the reliability and display performance of the display module. In addition, since the Dyne value of the first coating layer 40 is relatively high, that is, the Dyne value of the first coating layer 40 is greater than the Dyne value of the surface of the cover plate 20 adjacent to the adhesive layer 30. The use of the high-Dyne first coating layer 40 helps reduce bubble formation during the bonding process between the cover plate 20 and the adhesive layer 30, further enhancing the display performance of the display module.

In addition, since the first coating layer 40 is arranged between adjacent protrusions 23, the encapsulating effect of the protrusions 23 on the first coating layer 40 may reduce erosion of the coating material by external environmental factors, such as humidity and high temperature, thereby prolonging the stability of the interfacial bonding.

Furthermore, a surface of the cover plate 20 adjacent to the display panel 10 is provided with a plurality of protrusions 23, where the protrusions 23 are arranged in the second display region AA2. The protrusions 23 may serve as support points, effectively mitigating deformation of the second display region AA2 caused by impact during low-temperature drop testing. As a result, the protrusions 23 help reduce the shear force between the adhesive layer 30 and the cover plate 20 in the second display region AA2 during low-temperature drop testing, thereby reducing the risk of delamination and bubble formation between the adhesive layer 30 and the cover plate 20 and improving the reliability and display performance of the display module.

With continued reference to FIGS. 1 and 14, in some embodiments, a height of the first coating layer 40 is less than a height of the protrusions 23 in a direction perpendicular to the display panel 10; and a portion of the adhesive layer 30 is located between adjacent protrusions 23.

Specifically, a surface of the cover plate 20 adjacent to the display panel 10 is provided with a plurality of protrusions 23, and the protrusions 23 protrude in a direction toward the display panel 10. The first coating layer 40 is arranged between adjacent protrusions 23, and in a direction perpendicular to the display panel 10, a height of the first coating layer 40 is less than a height of the protrusions 23. That is, the first coating layer 40 does not completely fill the space between adjacent protrusions 23. As a result, when the cover plate 20 is bonded to the display panel 10, a portion of the adhesive layer 30 is located between the adjacent protrusions 23, such that the adhesive layer 30 is in contact with both the first coating layer 40 and the protrusions 23. The sidewalls of the protrusions 23 and the embedded portion of the adhesive layer 30 form an interlocking structure that effectively resists the shear force between the adhesive layer 30 and the cover plate 20 in the second display region AA2 during low-temperature drop testing. This configuration significantly reduces the risk of delamination and bubble formation between the adhesive layer 30 and the cover plate 20, thereby improving the reliability and display performance of the display module. Furthermore, because a portion of the adhesive layer 30 is located between adjacent protrusions 23, the contact area between the adhesive layer 30 and the cover plate 20 is increased, which may significantly enhance the adhesion strength between the adhesive layer 30, the first coating layer 40, and the cover plate 20, effectively reducing the risk of delamination and further improving the reliability of the display module.

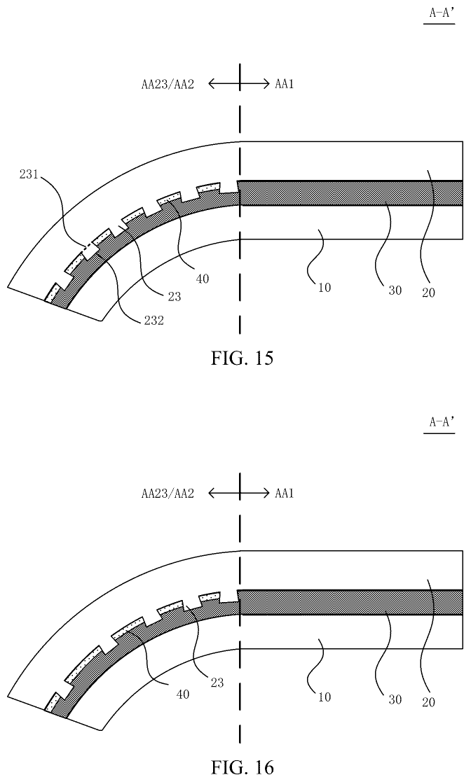

FIG. 15 illustrates yet another cross-sectional view of the display module shown in FIG. 1 along line A-A′. With reference to FIGS. 1 and 15, in some embodiments, a protrusion 23 includes a second bottom 231 and a second top 232, where the second bottom 231 and the second top 232 are arranged opposite to each other. The second bottom 231 is located at an end of the protrusion 23 away from the display panel 10, and the second top 232 is located at an end of the protrusion 23 close to the display panel 10. An area of a vertical projection pattern of the second bottom 231 onto the display panel 10 is less than an area of a vertical projection pattern of the second top 232 onto the display panel 10.

Specifically, a protrusion 23 includes a second bottom 231 and second top 232, where the second bottom 231 and the second top 232 are arranged opposite to each other. The second bottom 231 is located at an end of the protrusion 23 away from the display panel 10, and the second top 232 is located at an end of the protrusion 23 close to the display panel 10. A size of the second bottom 231 is smaller than a size of the second top 232. The first coating layer 40 is filled between adjacent protrusions 23, and in a direction perpendicular to the display panel 10, a height of the first coating layer 40 is less than a height of the protrusion 23. That is, the first coating layer 40 does not completely fill the space between adjacent protrusions 23. As a result, when the cover plate 20 is bonded to the display panel 10, a portion of the adhesive layer 30 is located between adjacent protrusions 23. The protrusions 23 and the adhesive layer 30 form an interlocking structure, which may further enhance the adhesion strength between the adhesive layer 30, the first coating layer 40, and the cover plate 20, effectively reducing the risk of delamination and improving the reliability of the display module.

FIG. 16 illustrates yet another cross-sectional view of the display module shown in FIG. 1 along line A-A′. With reference to FIGS. 1 and 16, in some embodiments, a density of the protrusions 23 gradually decreases in a direction from the first display region AA1 toward the second display region AA2.

Specifically, the curvature of the second display region AA2 is greater than the curvature of the first display region AA1. During low-temperature drop testing, the shear force generated in the second display region AA2 after impact is relatively large, with the greatest shear force occurring at the end of the second display region AA2 away from the first display region AA1. Accordingly, in a direction from the first display region AA1 toward the second display region AA2, the density of the protrusions 23 gradually decreases. Correspondingly, in the direction from the first display region AA1 toward the second display region AA2, an area of the first coating layer 40 arranged between adjacent protrusions 23 gradually increases. The first coating layer 40 has a relatively high Dyne value, and the first coating layer 40 arranged between adjacent protrusions 23 is advantageous for increasing the bonding strength between the adhesive layer 30 and the cover plate 20. As a result, in the direction from the first display region AA1 toward the second display region AA2, the bonding strength between the adhesive layer 30 and the cover plate 20 also gradually increases, such that in all regions of the second display region AA2, the bonding strength between the adhesive layer 30 and the cover plate 20 remains greater than the shear force generated therebetween after impact during low-temperature drop testing. Therefore, even when the adhesive properties of the adhesive layer 30 are reduced in a low-temperature environment, the adhesive layer 30 and the cover plate 20 in different regions of the second display region AA2 may remain firmly bonded. This reduces the risk that the shear force between the adhesive layer 30 and the cover plate 20 in the second display region AA2 during low-temperature drop testing may exceed the bonding strength therebetween, which may otherwise lead to delamination and bubble formation, thereby improving the reliability and display performance of the display module.

With continued reference to FIGS. 1 and 16, in some embodiments, a spacing between adjacent protrusions 23 gradually increases in a direction from the first display region AA1 toward the second display region AA2.

Specifically, the curvature of the second display region AA2 is greater than the curvature of the first display region AA1. During low-temperature drop testing, the shear force generated in the second display region AA2 after impact is relatively large, with the greatest shear force occurring at the end of the second display region AA2 away from the first display region AA1. Accordingly, in a direction from the first display region AA1 toward the second display region AA2, the spacing between adjacent protrusions 23 gradually increases. Correspondingly, the area of the first coating layer 40 arranged between adjacent protrusions 23 also gradually increases in the direction from the first display region AA1 toward the second display region AA2. The first coating layer 40 has a relatively high Dyne value, and the first coating layer 40 arranged between adjacent protrusions 23 is advantageous for increasing the bonding strength between the adhesive layer 30 and the cover plate 20. As a result, the bonding strength between the adhesive layer 30 and the cover plate 20 gradually increases in a direction from the first display region AA1 toward the second display region AA2, such that in all regions of the second display region AA2, the bonding strength between the adhesive layer 30 and the cover plate 20 remains greater than the shear force generated between the adhesive layer 30 and the cover plate 20 after impact during low-temperature drop testing. Therefore, even when the adhesive properties of the adhesive layer 30 are reduced in a low-temperature environment, the adhesive layer 30 and the cover plate 20 in different regions of the second display region AA2 may remain firmly bonded. This reduces the risk that the shear force between the adhesive layer 30 and the cover plate 20 in the second display region AA2 exceeds the bonding strength force between the adhesive layer 30 and the cover plate 20 during low-temperature drop testing, which may otherwise result in delamination and bubble formation, thereby improving the reliability and display performance of the display module.

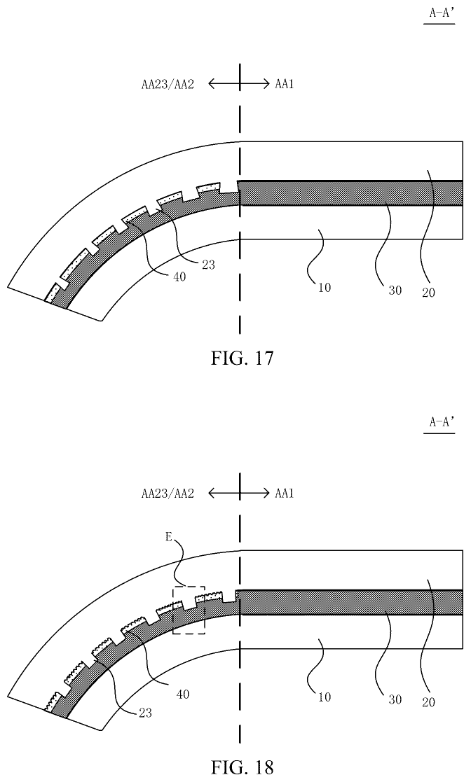

It should be noted that FIG. 16 illustratively shows that the density of the protrusions 23 gradually decreases in a direction from the first display region AA1 toward the second display region AA2, thereby achieving a gradual increase in spacing between adjacent protrusions 23 along the same direction. In some embodiments of the present disclosure, and with reference to FIGS. 1 and 17, where FIG. 17 illustrates yet another cross-sectional view of the display module shown in FIG. 1 along line A-A′, the spacing between adjacent protrusions 23 may also be gradually increased in a direction from the first display region AA1 toward the second display region AA2 by progressively reducing the size of the protrusions 23 along that direction. Further description is omitted herein.

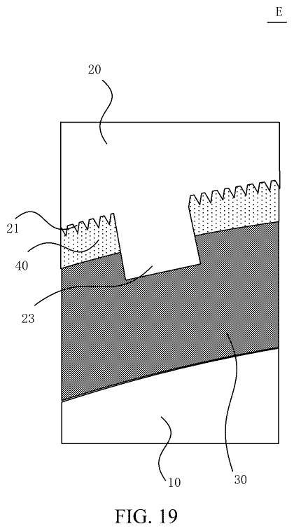

FIG. 18 illustrates yet another cross-sectional view of the display module shown in FIG. 1 along line A-A′, and FIG. 19 is an enlarged view of portion E of the display module shown in FIG. 18. With reference to FIGS. 1, 18, and 19, in some embodiments, a surface of the cover plate 20 adjacent to the display panel 10 is provided with a microprism structure 21, and the microprism structure 21 is arranged between adjacent protrusions 23.

Specifically, the microprism structure 21 is arranged between adjacent protrusions 23, which is advantageous for increasing the surface roughness in that region and facilitating the formation of the first coating layer 40 between adjacent protrusions 23. In addition, the microprism structure 21 increases the actual contact area between the first coating layer 40 and the portion of the cover plate 20 located between adjacent protrusions 23, which may significantly enhance the adhesion strength between the first coating layer 40 and the cover plate 20. This configuration effectively reduces the risk of delamination between the first coating layer 40 and the cover plate 20 and improves the reliability of the display module.

The curvature of the second display region AA2 is greater than the curvature of of the first display region AA1, meaning that the second display region AA2 is more highly curved. As a result, light emitted from the display panel 10 is more susceptible to reflective interference in the second display region AA2. In the second display region AA2, a microprism structure 21 is provided between adjacent protrusions 23, and the microprism structure 21 is capable of scattering light, which is advantageous for reducing reflective interference in the second display region AA2 and improving the display performance.

With continued reference to FIGS. 1, 18, and 19, in some embodiments, a height of the microprism structure 21 is less than a height of the protrusions 23 in a direction perpendicular to the display panel 10.

Specifically, the protrusions 23 protrude in a direction toward the display panel 10, and the first coating layer 40 is located between adjacent protrusions 23. In a direction perpendicular to the display panel 10, a height of the microprism structure 21 is less than a height of the protrusions 23, such that the presence of the microprism structure 21 does not interfere with the placement of the first coating layer 40 between the adjacent protrusions 23.

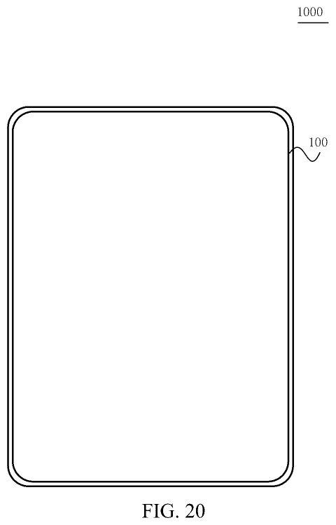

As shown in FIG. 20, FIG. 20 illustrates a schematic plan view of a display device provided according to some embodiments of the present disclosure. Various embodiments of the present disclosure further provide a display device 1000. The display device 1000 includes the display module 100 provided in any of the embodiments described above The embodiment illustrated in FIG. 20 takes a mobile phone as an example to describe the display device. It should be understood, however, that the display device provided in the embodiments of the present disclosure may be any type of electronic product having a display function, including but not limited to: mobile phones, televisions, notebook computers, desktop monitors, tablet computers, digital cameras, smart wristbands, smart glasses, in-vehicle displays, medical devices, industrial control equipment, and touch-interactive terminals. The present disclosure is not particularly limited in this regard.

The display device 1000 provided in the embodiments of the present disclosure includes the same technical features as the display module 100 described in the foregoing embodiments, and thus is capable of solving the same technical problems and achieving the same technical effects.

It should be noted that, in the present disclosure, relational terms such as “first” and “second” are used solely for distinguishing one entity or operation from another and do not necessarily imply any actual relationship or order between such entities or operations. In addition, the terms “comprise,” “include,” and any variations thereof are intended to cover non-exclusive inclusions, such that a process, method, article, or apparatus that comprises a list of elements is not necessarily limited to only those elements, but may also include other elements not explicitly listed or elements that are inherent to such a process, method, article, or apparatus. Without further limitation, an element defined by the phrase “comprising a . . . ” does not exclude the presence of additional elements of the same type in the process, method, article, or apparatus.

The above description is merely illustrative of specific embodiments of the present disclosure and is provided to enable those skilled in the art to understand and implement the present disclosure. Various modifications to these embodiments will be apparent to those skilled in the art. The general principles defined herein may be applied to other embodiments without departing from the spirit or scope of the present disclosure. Therefore, the present disclosure is not to be limited to the embodiments described herein, but is to be accorded the broadest scope consistent with the principles and novel features disclosed herein.

What is claimed is:

1. A display module, comprising:
a first display region and a second display region,
wherein the second display region surrounds at least a portion of the first display region, and a curvature of the second display region is greater than a curvature of the first display region;
a display panel, a cover plate, and an adhesive layer,
wherein the cover plate is located on a light-emitting side of the display panel, and the adhesive layer is arranged between the cover plate and the display panel; and
a first coating layer,
wherein the first coating layer is located in the second display region and arranged between the cover plate and the adhesive layer, and a Dyne value of the first coating layer is greater than a Dyne value of a surface of the cover plate adjacent to the adhesive layer.

2. The display module according to claim 1, wherein
a surface of the cover plate adjacent to the display panel is provided with a microprism structure, the microprism structure being located in the second display region; and
at least a portion of the microprism structure is in contact with the first coating layer.

3. The display module according to claim 2, wherein
in a direction from the first display region toward the second display region, a density of the microprism structure gradually increases.

4. The display module according to claim 1, wherein
a surface of the cover plate adjacent to the display panel is provided with a plurality of grooves, the plurality of grooves being recessed in a direction away from the display panel; and
the first coating layer is located within the plurality of grooves.

5. The display module according to claim 4, wherein
in a direction perpendicular to the display panel, a height of the first coating layer is equal to a depth of the plurality of grooves.

6. The display module according to claim 4, wherein
a height of the first coating layer is less than a depth of the plurality of grooves in a direction perpendicular to the display panel; and
a portion of the adhesive layer is located within the plurality of grooves.

7. The display module according to claim 6, wherein
the plurality of grooves comprise a first bottom and a first top, wherein
the first bottom and the first top are arranged opposite to each other;
the first bottom is located at an end of the plurality of grooves away from the display panel, and the first top is located at an end of the plurality of grooves adjacent to the display panel; and
an area of a vertical projection pattern of the first bottom onto the display panel is larger than an area of a vertical projection pattern of the first top onto the display panel.

8. The display module according to claim 4, wherein
a density of the plurality of grooves gradually increases in a direction from the first display region toward the second display region.

9. The display module according to claim 4, wherein
the plurality of grooves comprise a first bottom, the first bottom being located at an end of the plurality of grooves away from the display panel; and
an area of a vertical projection pattern of the first bottom onto the display panel gradually increases in a direction from the first display region toward the second display region.

10. The display module according to claim 4, wherein
the plurality of grooves comprise a first bottom, the first bottom being located at an end of the plurality of grooves away from the display panel; and
the first bottom is provided with a microprism structure.

11. The display module according to claim 10, wherein
a height of the microprism structure is less than a depth of the plurality of grooves in a direction perpendicular to the display panel.

12. The display module according to claim 1, wherein
a surface of the cover plate adjacent to the display panel is provided with a plurality of protrusions, the plurality of protrusions protruding in a direction toward the display panel; and
the first coating layer is arranged between adjacent protrusions of the plurality of protrusions.

13. The display module according to claim 12, wherein
a height of the first coating layer is less than a height of the plurality of protrusions in a direction perpendicular to the display panel; and
a portion of the adhesive layer is located between adjacent protrusions of the plurality of protrusions.

14. The display module according to claim 13, wherein
the plurality of protrusions comprise a second bottom and a second top, wherein
the second bottom and the second top are arranged opposite to each other;
the second bottom is located at an end of the plurality of protrusions away from the display panel, and the second top is located at an end of the plurality of protrusions adjacent to the display panel; and
an area of a vertical projection pattern of the second bottom onto the display panel is less than an area of a vertical projection pattern of the second top onto the display panel.

15. The display module according to claim 14, wherein
a density of the plurality of protrusions gradually decreases in a direction from the first display region toward the second display region.

16. The display module according to claim 12, wherein
in a direction from the first display region toward the second display region, a spacing between adjacent protrusions of the plurality of protrusions gradually increases.

17. The display module according to claim 12, wherein
a surface of the cover plate adjacent to the display panel is provided with a microprism structure; and
the microprism structure is arranged between adjacent protrusions of the plurality of protrusions.

18. The display module according to claim 17, wherein
a height of the microprism structure is less than a height of the plurality of protrusions in a direction perpendicular to the display panel.

19. The display module according to claim 1, wherein
the second display region comprises a first edge region, a second edge region, and a corner region, wherein
an extending direction of the first edge region intersects with an extending direction of the second edge region, and the first edge region and the second edge region intersect at the corner region; and
the first coating layer is located at least in the corner region.

20. A display device, comprising a display module, wherein the display module comprises:
a first display region and a second display region,
wherein the second display region surrounds at least a portion of the first display region, and a curvature of the second display region is greater than a curvature of the first display region;
a display panel, a cover plate, and an adhesive layer,
wherein the cover plate is located on a light-emitting side of the display panel, and the adhesive layer is arranged between the cover plate and the display panel; and
a first coating layer,
wherein the first coating layer is located in the second display region and arranged between the cover plate and the adhesive layer, and a Dyne value of the first coating layer is greater than a Dyne value of a surface of the cover plate adjacent to the adhesive layer.
